(19) United States
(12) Patent Application Publication
(10) Pub. No.: US 2010/0122418 A1
(43) Pub. Date: May 20, 2010

(54) FULL-BODY INCLINED MATTRESS

(76) Inventor: Stephen D. Adler, Thousand Oaks, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/614,605

(22) Filed: Nov. 9, 2009

Related U.S. Application Data
(60) Provisional application No. 61/114,524, filed on Nov. 14, 2008.

(51) Int. Cl. A47C 27/08; A47C 27/14; A47C 23/00; A61G 7/00

(52) U.S. Cl. 5/691

(57) ABSTRACT

A full-body auxiliary mattress for reducing acid reflux in a person lying on a flat surface, the auxiliary mattress comprising a head end, a foot end, a flat bottom and an inclined top to elevate the person's body, the auxiliary mattress top gradually inclining from the foot of the auxiliary mattress upward to the head of the auxiliary mattress.

This application claims the benefit of U.S. Provisional Application Ser. No. 61/114,524, filed Nov. 14, 2008, which application is incorporated herein by reference in its entirety.

### FIELD OF THE INVENTION

The present invention involves reducing, during periods of rest or sleep, the negative effects of indigestion, heartburn, (GERD) Gastroesophageal Reflux Disease, conditions generally referred to herein as acid reflux.

### BACKGROUND OF THE INVENTION

Acid reflux is characterized by symptoms of burning or acid regurgitation produced by the abnormal reflux of gastric contents into the esophagus. The major mechanism for acid reflux is transient relaxation of the lower esophageal sphincter (LES) (Kaltenbach, et al, 2006) Some research indicates that 40-44% of Americans (120-132 Million) are affected by monthly symptoms of heartburn; 14% (42 Million) experience symptoms once a week; and 7% (21 Million) experience symptoms daily (Ibid). Another source estimates that 25-75 Million people in the United States actually have GERD (Giacci, 2006).

GERD can lead to extremely serious medical conditions. Significant morbidity and mortality can be attributed to complications of chronic GERD, including increased risk of developing Barrett's esophagus, esophageal adenocarcinoma (Westoff et al., 2005), peptic strictures (Richter, 1999), laryngitis (Qadeer et al., 2006), chronic cough, and GERD-induced asthma (Lazenby & Harding, 2000). Additionally, GERD has been associated with a much lower health-related quality of life than the general population, with impairments similar to other chronic diseases (Salyers, et al., 2006).

Lifestyle modifications are first-line therapy for patients with GERD. (Kaltenbach et al., 2006) Recommendations for lifestyle modifications are based on the presumption that certain foods, body position, tobacco, alcohol and obesity contribute to a dysfunction in the body's anti-reflux defense system. Accordingly, the American College of Gastroenterology recommends the use of lifestyle changes, including elevation of the head of the bed (HOB); decreased fat, chocolate, alcohol, peppermint and coffee intake; cessation of smoking; and avoiding recumbency for three hours after eating, in addition to anti-reflux medical treatment. Other sources recommend reduction of citrus fruits and juices, tomato-based products, spicy foods and carbonated beverages (Ibid).

GERD is more dangerous at night. Nearly eight in ten heartburn sufferers experience symptoms at night (Article entitled “10 Steps to Lessening Nighttime Heartburn” posted on About.com by Sharon Gillson, reviewed by Medical Review Board Apr. 18, 2008). Patients with nighttime GERD also tend to experience severe pain and irritation (Article entitled “Nighttime Heartburn May Be Dangerous” posted on About.com by Sharon Gillson, reviewed by Medical Review Board Feb. 14, 2006). When symptoms of GERD occur at night, they can be more damaging than those same symptoms during the day (Ibid). This is because the body is less prepared to deal with these symptoms and less able to prevent possible lasting damage. (Ibid). Potentially harmful factors that make nighttime heartburn more likely to cause damage include:

1) Lying flat in bed allows stomach acid to flow more easily into the esophagus and stay there for longer periods of time than when a person is in an upright position (Ibid).

2) When GERD sufferers are awake and there is an episode of acid reflux, they often will rinse their mouth or swallow some liquid. Even swallowing saliva helps because it neutralizes the acid. However, a person cannot drink or swallow every time an acid reflux episode occurs while sleeping. When asleep, once the refluxed acid is in the esophagus or throat, the sufferer isn't always aware of it, and thus doesn't take steps to rinse the acid away (Ibid).

3) There is an increased risk of choking on refluxed stomach contents. If refluxed acid is in the throat and mouth, a GERD sufferer can inhale it into his or her lungs. Once in the lungs, it can cause a GERD sufferer to cough and choke on this aspirated material. The acid can also cause the same damage to the lungs as it can cause when refluxed into the esophagus.

Medical professionals agree it is important to take preventative measures before going to sleep to mitigate the effects of nighttime acid reflux. The most common suggestions for preventing acid reflux at night are:

1) After meals, take a walk or, at the very least remain upright.

2) Avoid bedtime snacks. In general, avoid eating for at least two hours prior to bedtime.

3) Avoid eating fatty or spicy foods, chocolate, citrus fruits, peppermint, tomato-based foods and peanuts at dinner (or anytime).

4) Avoid drinking alcohol and carbonated beverages at dinner (or anytime).

5) Eat small meals.

6) Avoid smoking before going to bed.

7) When going to bed, try lying on the left side rather than on the right. The stomach is located higher than the esophagus when a person sleeps on the right side, which can put pressure on the lower esophageal sphincter (LES), increasing the risk for fluid backup.

8) Sleep with the head of the bed elevated so the body is in a tilted position to help keep acid in the stomach at night.

Numerous patents have been issued involving methods of raising the head of the bed. U.S. Pat. No. 6,925,670 describes a bed in which approximately one-half of the top surface is horizontal and one-half is inclined.

U.S. Pat. No. 6,684,425 discloses a mattress in which a portion can be inclined by use of an air chamber.

U.S. Pat. Nos. 6,681,425 and 6,739,005 describe beds in which one or more sections of the bed may be raised at an angle using air chambers.

U.S. Pat. No. 5,870,784 discloses a bed in which a motor can move the back portion from a generally flat orientation to a raised orientation.

U.S. Pat. No. 7,360,266 describes a multiple position air mattress in which the head portion can be inclined. This type of mattress position is commonly called a “wedge” because a head section of the mattress can be raised but the foot section of the mattress remains horizontal. Gastroenterologists often advise patients to elevate the head of the bed or try a wedge product to try to diminish the exposure of the esophagus to refluxed acid. The theory is simple: Gravity keeps the acid in the stomach and out of the esophagus. There is, of course, inconvenience caused by elevating the head of the bed, but this method is not only an effective means of reducing acid reflux at night but also more comfortable than the wedge. Another recommendation is to raise the entire bed frame on blocks as opposed to using a wedge or multiple pillows, the presumption being that the patient would slide down from the pillows. There are practical issues concerning head of bed (HOB) elevation, in that head of bed elevation not only requires some carpentry effort, but it also has a major impact on the sleeping habits of the spouse, in that the patient and spouse both are placed in that position and often both slide to the end of the bed in an uncomfortable position.

The problems with HOB elevation are two-fold. First, it is extremely difficult, if not impossible, to raise the head of a large bed on blocks. Many people have queen and king-size beds with heavy wood frames and headboards. Assuming this can be accomplished, it is often the experience that the non-suffering spouse tends to become extremely annoyed at having to sleep on an angle all night.

### DESCRIPTION OF THE INVENTION

The solution to the above problems is a product which effectively reduces nighttime reflux, is easy to use and does not bother the non-suffering spouse. It comprises an inflatable, foam or spring mattress, which is placed directly on top of a flat, horizontal surface, such as a bed. It is a wedge-like product that fits under the entire body, not just behind the back as described in the prior art. The full-body incline of the mattress of this invention is as effective as HOB elevation in reducing nighttime acid reflux occurrence and is more effective than a partial incline or the behind-the-back wedge, because it puts less pressure on the mid-section than the wedge. In fact, the behind-the-back wedge may actually increase acid reflux due to this pressure.

Moreover, the full-body incline mattress is much more comfortable than behind-the-back wedge products because it allows the person to sleep on his/her back, side or stomach without putting undo pressure on either the mid-section or the back. Last, but not least, this full-body anti-reflux mattress allows the spouse to sleep undisturbed in a flat horizontal position on the usual mattress, because the full-body incline mattress may only cover about one-half of the width of the bed, giving the other half to the spouse to sleep in a normal horizontal position.

### BRIEF DESCRIPTION OF THE DRAWINGS

The present invention may be better understood by reading the detailed description of the preferred embodiment with reference to the drawings, wherein:

FIG. 1 is a perspective view of the full body inclined mattress on a bed;

FIG. 2 is a perspective view of the invention in use on a mattress;

FIG. 3 is a perspective view of the invention in a deflated state, on a mattress;

FIG. 4 is a perspective view of the invention with a pillow cut-out; and

FIG. 5 is a side elevational view.

### DESCRIPTION OF THE PREFERRED EMBODIMENT

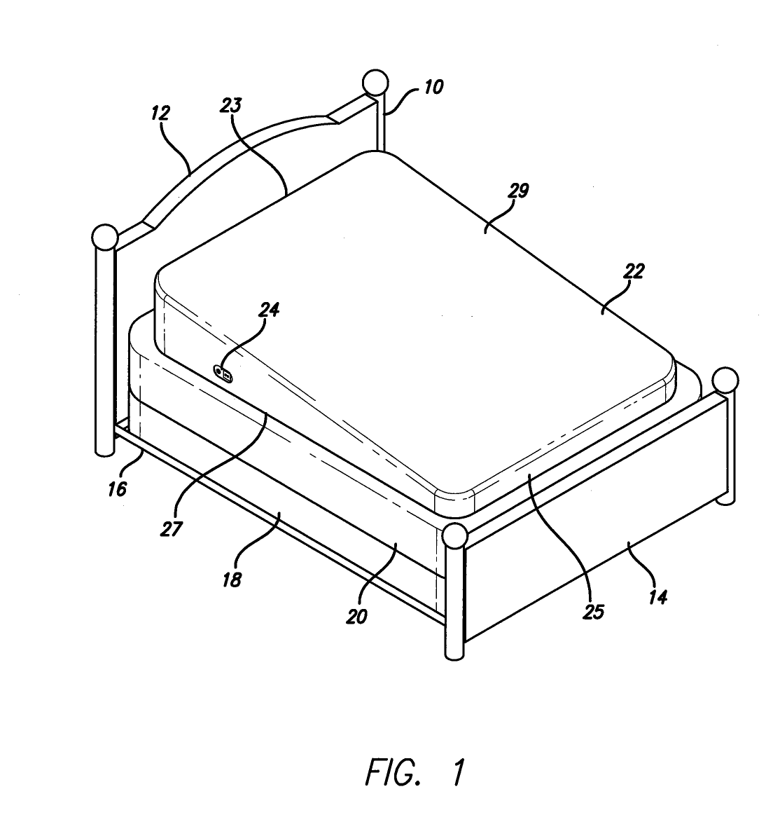

Referring to FIGS. 1 through 5 there is shown a standard bed 10, having a headboard 12, a footboard 14, a base 16, an innerspring 18 and a mattress 20. Lying on the top of mattress 20 is an inflatable, inclined, full-body, auxiliary mattress 22 having an optional inflation means 24. Auxiliary mattress 22 has a head end 23, a foot end 25, a flat bottom 27 and a straight but gradually inclined top 29. The degree of incline of top 29 is consistent (the same) from foot end 25 to head end 23.

Inflatable mattress 22 may be inflated by blowing into a tube or by a battery or an electric powered pump, which fills the mattress with air and can also deflate the mattress.

As shown in FIG. 1, inflatable mattress 22 covers the entire width of mattress 20. Bed 10 may be a single, double, queen or king sized bed of any dimension.

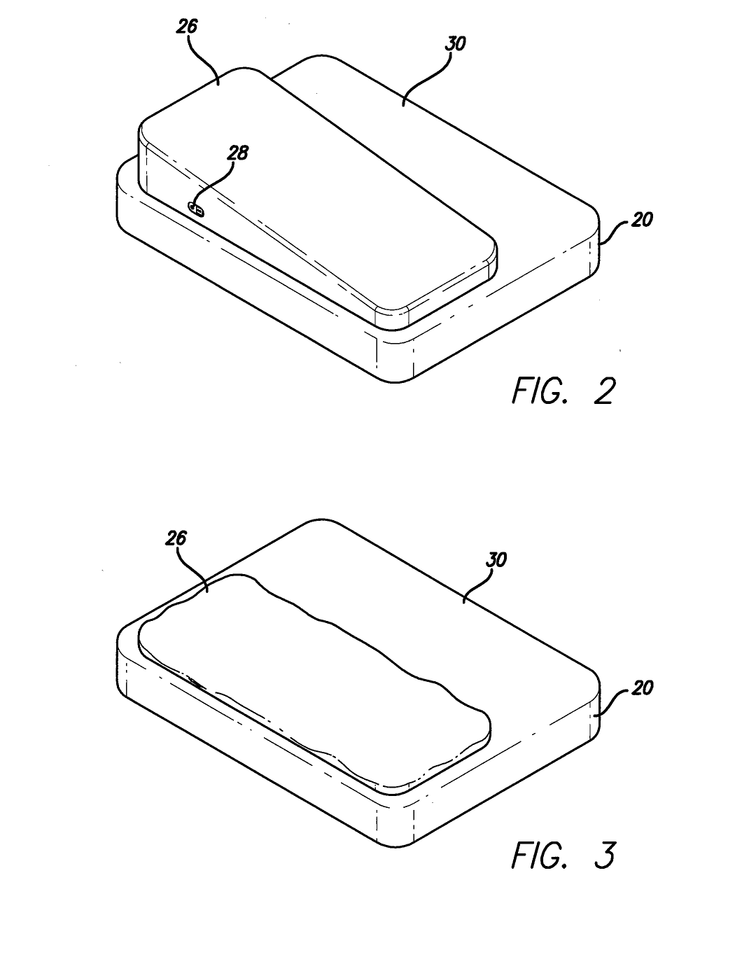

Referring to FIG. 2, there is shown mattress 20 with an inflatable, inclined auxiliary mattress 26, which is only about one-half the width of mattress 20, so that a spouse can sleep on the horizontal portion 30 of mattress 20 and the couple can still sleep in the same bed, if desired. Inflatable, inclined mattress 26 has means 28 to inflate and deflate the mattress, as described in FIG. 1.

FIG. 3 shows the inflatable, inclined mattress 26 in a deflated state.

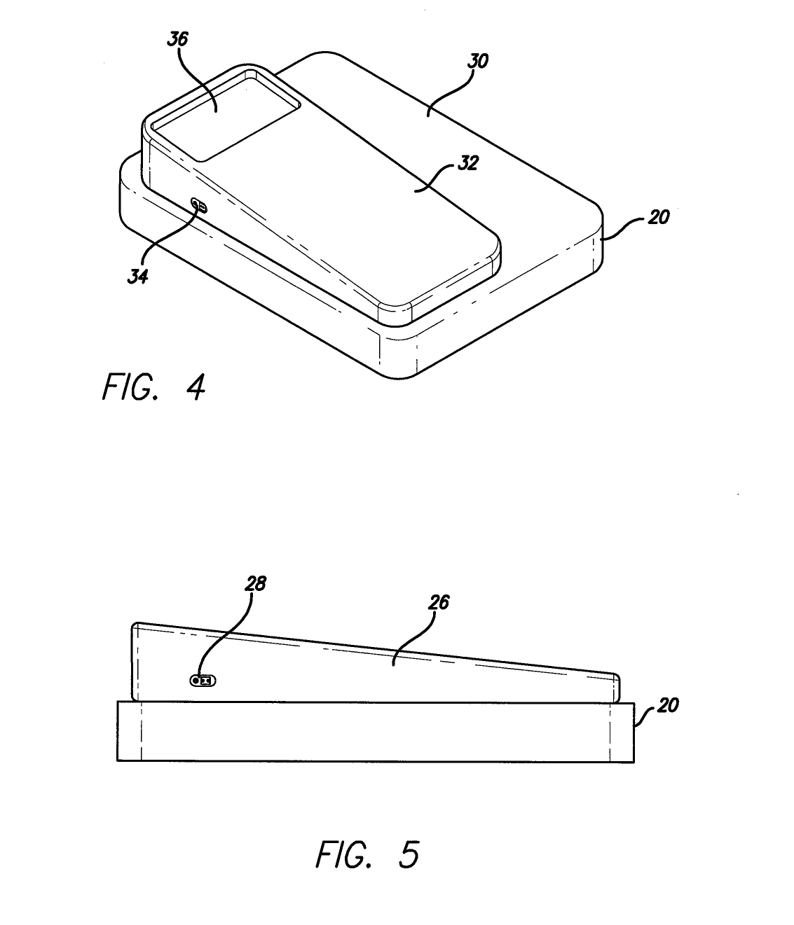

Referring to FIG. 4, there is shown mattress 20 with inflatable, inclined mattress 32, which covers about one-half of the width of mattress 20 leaving horizontal portion 30. Inflatable, inclined mattress 32 has means 34 to inflate and deflate mattress 32, as described above. In this embodiment, inflatable, inclined mattress 32 has a built-in cut-out or depression 36, for placement of a pillow. For some users, placing their pillow in cut-out 36 is more comfortable than using a pillow without cut-out 36, because it creates a more uniform incline. Cut-out 36 could also be a gradual depression running from side to side of mattress 32, or any other desired width.

FIG. 5 shows a side elevational view of inflatable, inclined, auxiliary mattress 26, on mattress 20, having inflation/deflation means 28.

The inflatable version of this invention is portable for use at home or while traveling. Typical dimensions of the inflatable version, that covers about one-half the width of a standard California king bed are: 8″ high at the head; 78″ long; 28″ wide at the head; 28″ wide at the foot; and 1¾″ high at the foot, which creates an angle of incline of about 5°. However, the range of angles of incline depend upon the needs and comfort of the user. The incline can vary from about 3° to about 10° or more if needed, and preferably from about 4° to about 7°. The length and width of the mattress vary depending on the size of the bed and the size of the user. The important thing is that gravity prevents burning and/or acid regurgitation produced by the abnormal reflux of gastric contents into the esophagus.

The mattress version of the product with coils and springs has similar dimensions and provides even greater support and comfort. In addition, the full-body, inclined mattress of this invention, whether it is inflatable, foam or innerspring, can be custom made to any size desired by the user. The key is that the incline is full-body, head to toe, which provides the benefits described above.

The user may use any normal bed linens, sheets, blankets, etc. on the full-body inclined mattress of this invention, or a fitted sheet may be made to fit the shape of the mattress which will stay in place better than a non-fitted sheet.

A carrying case may also be used to carry any version of the auxiliary mattress, which may, or may not be foldable, so that the user can take it with him or her when traveling away 180 from home.

Tests Conducted

I, the inventor hereof, was diagnosed with GERD about five years ago. I experienced symptoms daily, especially at night. In addition to making dietary and lifestyle changes, I tried raising the head of the bed (6-8 inches) inclining the entire bed. I also tried two commercially available wedge products. One wedge was made of foam and measured 7 inches high at the head, 25 inches long and 24 inches wide, tapering to about half an inch at the bottom. The other wedge was inflatable and measured 6 inches high at the head, 24 and-a-half inches long and 24 inches wide, tapering to about half an inch at the bottom. I also tried using various assortments of pillows. After many months of experimentation, my experience with HOB elevation, wedges and pillows were that, while wedges were clearly more convenient to use and less of an annoyance to my wife than HOB elevation, they were much more uncomfortable than HOB elevation. Since the upper body is at an angle and the legs are flat and straight, I found that the only conceivable sleeping position on a wedge was on the back. This tended to put pressure on the mid-section which was both uncomfortable and caused reflux episodes. When trying to sleep on my stomach or side, the angle of the wedge put pressure on the lower back which caused stiffness and spasms. Pillows could be arranged in a comfortable position, but ultimately moved around so that I ended up sleeping in a flat position during the night.

I found head of bed elevation at 6-8 inches to be more effective than the wedges and clearly more comfortable, however it was a difficult job to raise the head of the entire bed and my wife was forced to sleep in the same inclined position. My invention of the full-body, inclined, auxiliary mattress, covering only about one-half of the width of our bed, solved all of our problems, including greatly alleviating my GERD symptoms during sleep.

Having thus described the invention, I Claim:

1. A full-body auxiliary mattress for reducing acid reflux in a person lying on a flat surface, the auxiliary mattress comprising a head end, a foot end, a flat bottom and an inclined top to elevate the person's body, the auxiliary mattress top gradually inclining from the foot of the auxiliary mattress upward to the head of the auxiliary mattress, the auxiliary mattress being placed on the top of the flat surface.

2. The auxiliary mattress of claim 1 in which the auxiliary mattress is an inflatable mattress, an innerspring mattress or a foam mattress.

3. The auxiliary mattress of claim 1 in which the incline of the auxiliary mattress top is from about 3 degrees to about 10 degrees.

4. The auxiliary mattress of claim 1 in which the incline of the auxiliary mattress top is from about 4 degrees to about 7 degrees.

5. The auxiliary mattress of claim 1 further comprising a depression at the head end of the mattress adapted to hold a pillow.

6. The auxiliary mattress of claim 1 in which the auxiliary mattress is inflatable and comprises an automatic inflation device.

7. The auxiliary mattress of claim 1 further comprising a carrying case for an inflatable or foam auxiliary mattress.

8. The auxiliary mattress of claim 1 in which the inflatable and foam auxiliary mattresses are foldable.

9. The auxiliary mattress of claim 1 further comprising fitted sheets adapted to fit tightly on the auxiliary mattress.

10. The auxiliary mattress of claim 1 in which the flat surface is a bed.

11. The auxiliary mattress of claim 10 in which the width of the auxiliary mattress is substantially the same as the width of the bed.

12. The auxiliary mattress of claim 10 in which the width of the auxiliary mattress is approximately one-half of the width of the bed.
